(19) United States
(12) Patent Application Publication
(10) Pub. No.: US 2014/0232179 A1
(43) Pub. Date: Aug. 21, 2014

(54) VEHICLE AND METHOD OF CONTROLLING VEHICLE

(71) Applicants: Takahiko Hirasawa, Toyota-shi (JP); Masashi Yoshimi, Toyota-shi (JP)

(72) Inventors: Takahiko Hirasawa, Toyota-shi (JP); Masashi Yoshimi, Toyota-shi (JP)

(73) Assignee: TOYOTA JIDOSHA KABUSHIKI KAISHA, Toyota-shi Aichi-ken (JP)

(21) Appl. No.: 14/347,100

(22) PCT Filed: Sep. 26, 2011
(86) PCT No.: PCT/JP2011/005400

§ 371 Date: Apr. 16, 2014

(51) Int. Cl. H02J 4/00

(52) U.S. Cl. CPC H02J 4/00
USPC 307/9.1

(57) ABSTRACT

A vehicle includes a feeding system supplying an electric power to an external device disposed outside the vehicle, a controller controlling the operation of the feeding system, and a shift sensor detecting the position of a shift lever and outputting the detection result to the controller. The controller prohibits feeding from the feeding system to the external device when the position of the shift lever is changed.

### TECHNICAL FIELD

The present invention relates to a vehicle capable of supplying an electric power to a device disposed outside the vehicle and a method of controlling the vehicle.

### BACKGROUND ART

Patent Document 1 has described a system in which a battery mounted on a vehicle supplies an electric power to a device (external device) disposed outside the vehicle. Patent Document 2 has described a system in which, when the capacity of a battery mounted on a vehicle is reduced, an engine is started to cause an alternator to generate an electric power which is then supplied to an external device.

### PRIOR ART DOCUMENTS

### Patent Documents

[Patent Document 1] Japanese Patent Laid-Open No. 2008-236902

[Patent Document 2] Japanese Patent Laid-Open No. 2007-236023

[Patent Document 3] Japanese Patent Laid-Open No. 2005-329931

[Patent Document 4] Japanese Patent Laid-Open No. 2006-320065

[Patent Document 5] Japanese Patent Laid-Open No. 2006-020455

### DISCLOSURE OF THE INVENTION

### Problems to be Solved by the Invention

When the electric power is supplied from the vehicle to the external device, the vehicle is preferably in a state in which it starts to supply the electric power to the external device. Particularly when the external device is used remotely from the vehicle, the vehicle is preferably in a state in which it starts to supply the electric power to the external device.

### Means for Solving the Problems

According to a first aspect, the present invention provides a vehicle including a feeding system supplying an electric power to an external device disposed outside the vehicle, a controller controlling the operation of the feeding system, and a shift sensor detecting the position of a shift lever and outputting the detection result to the controller. The controller prohibits feeding from the feeding system to the external device when the position of the shift lever is changed.

According to the first aspect of the present invention, the electric power can be supplied from the feeding system to the external device while the position of the shift lever is unchanged. Since the shift lever is maintained at the position detected when the supply of the electric power to the external device is started, the vehicle can be maintained in a state in which it starts the feeding.

An electric storage apparatus can be used as the feeding system. The electric storage apparatus can output an electric power used in running of the vehicle and an electric power to be supplied to the external device. In addition, the feeding system can be provided by using an engine producing a motive power through combustion of a fuel and a generator receiving the motive power from the engine to generate an electric power.

The feeding to the external device can be prohibited when the position of the shift lever is changed from a parking range to another range. The feeding to the external device can be performed while the shift lever is maintained at the parking range. In other words, the vehicle can remain stopped during the feeding to the external device. When the external device is used remotely from the vehicle, the vehicle can be left stopped.

The feeding from the feeding system to the external device can be prohibited when the position of the shift lever is unchanged and an accelerator pedal is operated. The feeding to the external device can be reliably performed until the operation of the accelerator pedal. An accelerator position sensor can be used to detect the operation of the accelerator pedal.

The feeding from the feeding system to the external device can be prohibited when the position of the shift lever is unchanged and a brake is operated. The feeding to the external device can be reliably performed until the operation of the brake. A brake sensor can be used to detect the operation of the brake. The operation of the brake includes the operation of a brake pedal and the operation of a parking brake.

When the feeding to the external device is prohibited, feeding prohibition information can be output from an information output unit. A display or a speaker can be used as the information output unit. A user can recognize the prohibition of the feeding with a representation shown on the display or a sound output from the speaker.

The information output unit can transmit the feeding prohibition information to a portable device. The user can recognize the prohibition of the feeding using the portable device. When the portable device includes a display, the feeding prohibition information can be shown on the display. The user can recognize the prohibition of the feeding by seeing a representation on the display. When the portable device includes a speaker, the feeding prohibition information can be output as a sound from the speaker. The user can recognize the prohibition of the feeding by listening to the sound.

The feeding prohibition information can include information representing the prohibition of the feeding and information representing the reason for the prohibition of the feeding. The user can recognize not only the prohibition of the feeding but also the reason for the prohibition of the feeding.

According to a second aspect, the present invention provides a control method of controlling the operation of a feeding system mounted on a vehicle and supplying an electric power to an external device disposed outside the vehicle. The control method includes detecting the position of a shift lever using a shift sensor, and prohibiting feeding from the feeding system to the external device when the position of the shift lever is changed. The second aspect of the present invention can achieve the same advantages as those in the first aspect.

### BRIEF DESCRIPTION OF THE DRAWINGS

FIG. 1 is a diagram showing part of a system mounted on a vehicle.

FIG. 2 is a flow chart showing the processing of supplying an electric power to an external device.

### MODE FOR CARRYING OUT THE INVENTION

An embodiment of the present invention will hereinafter be described.

### Embodiment 1

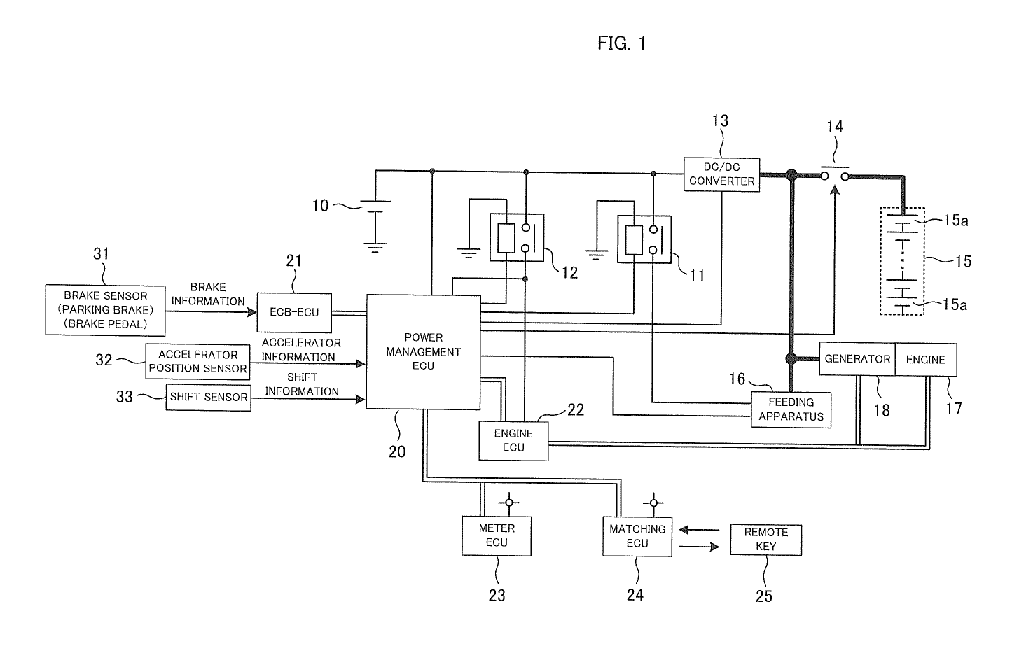

A vehicle which is Embodiment 1 of the present invention is described with reference to FIG. 1. FIG. 1 is a diagram showing part of a system mounted on the vehicle. The vehicle of the present embodiment can be run by using the outputs from an assembled battery (corresponding to an electric storage apparatus) and an engine.

An auxiliary battery 10 supplies an electric power to auxiliaries mounted on the vehicle. In the system shown in FIG. 1, the auxiliary battery 10 supplies the electric power to a power management ECU (electronic control unit) 20, an engine ECU 22, a DC/DC converter 13, and a feeding apparatus 16. Each thin line shown in FIG. 1 indicates a line on which the electric power is supplied from the auxiliary battery 10. The auxiliaries also include air-conditioning equipment, a radio, and a car navigation system. The auxiliary battery 10 is formed of a secondary battery such as a lead-acid battery.

An IG relay 11 receives a control signal from the power management ECU 20 to switch between ON and OFF. While the IG relay 11 is ON, the electric power of the auxiliary battery 10 can be supplied to the feeding apparatus 16 to operate the feeding apparatus 16. An IG relay 12 receives a control signal from the power management ECU 20 to switch between ON and OFF. While the IG relay 12 is ON, the electric power of the auxiliary battery 10 can be supplied to the engine ECU 22 to operate the engine ECU 22.

The DC/DC converter 13 converts a voltage output from an assembled battery 15 into a voltage to be supplied to the auxiliary battery 10. Specifically, the DC/DC converter 13 drops the voltage output from the assembled battery 15 and outputs the dropped electric power to the auxiliary battery 10. The supply of the electric power from the assembled battery 15 to the auxiliary battery 10 can charge the auxiliary battery 10.

The DC/DC converter 13 is connected to the assembled battery 15 through a system main relay 14. The system main relay 14 receives a control signal from the power management ECU 20 to switch between ON and OFF. While the system main relay 14 is ON, the electric power of the assembled battery 15 can be output to the DC/DC converter 13 or the electric power output from the assembled battery 15 can be used to run the vehicle.

For running the vehicle using the electric power output from the assembled battery 15, an inverter is used to convert a DC power output from the assembled battery 15 into an AC power. The AC power (electric energy) is supplied to a motor generator coupled to wheels. This allows the motor generator to generate a kinetic energy for running of the vehicle.

For stopping or decelerating the vehicle, the motor generator converts a kinetic energy generated in braking of the vehicle into an electric energy (AC power). The inverter converts the AC power generated by the motor generator into a DC power and outputs the DC power to the assembled battery 15. Thus, the regenerative power can be stored in the assembled battery 15.

The assembled battery 15 includes a plurality of cells 15a connected electrically in series. The cell 15a can be provided by using a secondary battery such as a nickel metal hydride battery or a lithium-ion battery. An electric double layer capacitor may be used instead of the secondary battery.

The number of the cells 15a constituting the assembled battery 15 can be set as appropriate in view of the output and the like required of the assembled battery 15. The voltage of the assembled battery 15 is higher than the voltage of the auxiliary battery 10. The assembled battery 15 may include a plurality of cells 15a connected electrically in parallel. Each thick line shown in FIG. 1 indicates a line on which the electric power is supplied from the assembled battery 15.

An engine 17 generates a motive power through combustion of a fuel. The fuel is stored in a fuel tank mounted on the vehicle. The engine 17 is provided by using a gasoline engine, a diesel engine, and an engine involving combustion of a gaseous fuel such as liquefied petroleum gas or natural gas. The engine 17 is coupled to the wheels, and the motive power generated by the engine 17 is transferred to the wheels to enable the running of the vehicle.

A generator 18 uses the motive power generated by the engine 17 to generate an electric power. The generator 18 can generate an AC power, for example. The engine ECU 22 controls the operations of the engine 17 and the generator 18.

The feeding apparatus 16 converts the DC power output from the assembled battery 15 into an AC power or converts the electric power generated by the generator 18 into a predetermined electric power. The feeding apparatus 16 can provide an AC power at 100 V, for example. The AC power provided by the feeding apparatus 16 can be output to the outside of the vehicle. Extra electric power generated by the generator 18 can be supplied to the assembled battery 15 to charge the assembled battery 15.

The vehicle is provided with a receptacle connected to the feeding apparatus 16. A plug of the external device can be inserted into the receptacle to supply the electric power output from the feeding apparatus 16 to the external device. The external device is a device provided independently of the vehicle and outside the vehicle. It is only required that the external device should operate with the supply of an AC power. An electrical appliance is an example of the external device.

In the present embodiment, the electric power of the assembled battery 15 is first supplied to the external device through the feeding apparatus 16. When the assembled battery 15 is discharged to reduce the State of Charge (SOC) of the assembled battery 15 below a threshold value, the power management ECU 20 starts the engine 17. The SOC represents a ratio of the current charge capacity to the full charge capacity of the assembled battery 15. The start of the engine 17 allows the generator 18 to generate an electric power which then can be supplied to the external device through the feeding apparatus 16. The start of the engine 17 consumes the fuel.

An Electronically Controlled Brake (ECB)-ECU 21 receives brake information from a brake sensor 31. The ECB-ECU 21 transmits the brake information to the power management ECU 20. The brake sensor 31 includes a brake sensor detecting the operation state of a parking brake and a brake sensor detecting the operation state of a brake pedal. A double line shown in FIG. 1 indicates a communication line.

The power management ECU 20 receives accelerator information from an accelerator position sensor 32. The accelerator position sensor 32 is attached on an accelerator pedal and outputs a signal based on the operation of the accelerator pedal as the accelerator information.

The power management ECU 20 receives shift information from a shift sensor 33. The shift sensor 33 outputs a signal based on the operation position of a shift lever as the shift information. Examples of the operation position (shift position) of the shift lever include a P-range (parking), an R-range (rearward), an N-range (neutral), and a D-range (forward).

In the present embodiment, the vehicle can be started while the shift position is at the P-range. In other words, the power management ECU 20 permits the activation of the system shown in FIG. 1 while the shift position is at the P-range. While the shift position is at the P-range, the power management ECU 20 can receive the input of an activation instruction to activate the system shown in FIG. 1. The activation instruction can be output to the power management ECU 20 through the operation of a switch placed on the vehicle or the operation of a remote key 25.

A meter ECU 23 receives information from the power management ECU 20 to display particular information on a display mounted on the vehicle or to output particular information from a speaker. For example, the meter ECU 23 can display the running speed of the vehicle, the remaining fuel amount, and the charge/discharge state of the assembled battery 15 on the display.

A matching ECU 24 wirelessly communicates with the remote key 25. The matching ECU 24 can receive information from the remote key 25 to perform matching. Specifically, the matching ECU 24 can determine whether or not identification information owned by the matching ECU 24 matches identification information transmitted from the remote key 25 and output the information of the determination to the power management ECU 20.

When there is a match between the two identification information items, the vehicle can be started through the operation of the remote key 25. The operation of the remote key 25 can also activate the feeding apparatus 16 to supply the electric power from the feeding apparatus 16 to the external device. The remote key 25 can be provided with a display or a speaker.

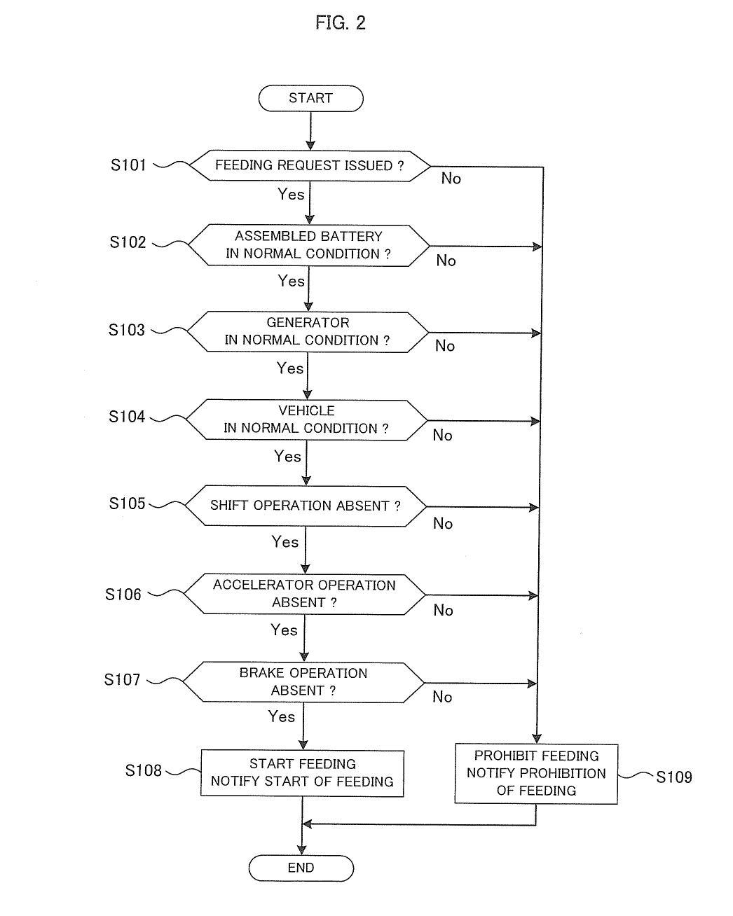

Next, description is made of the processing performed when the electric power is supplied to the external device in the vehicle of the present embodiment with reference to a flow chart shown in FIG. 2. The processing shown in FIG. 2 is performed by the power management ECU 20.

At step S101, the power management ECU 20 determines whether or not a feeding request is issued. When the feeding request is issued, the power management ECU 20 proceeds to processing at step S102. When no feeding request is issued, the power management ECU 20 proceeds to processing at step S109.

The information about the feeding request is input to the power management ECU 20. For example, the vehicle may be provided with a switch for feeding, and when the switch is operated, the information about the operation of the switch may be input to the power management ECU 20. In response to the input signal from the switch, the power management ECU 20 can determine that the feeding request is issued.

Alternatively, the feeding request may be issued through the operation of the remote key 25. For issuing the feeding request through the operation of the remote key 25, matching processing is first performed between the remote key 25 and the matching ECU 24. After the matching processing is completed, the matching ECU 24 transmits the information about the operation of the remote key 25 to the power management ECU 20. When the feeding request is issued through the operation of the remote key 25, the information about the feeding request is transmitted from the matching ECU 24 to the power management ECU 20. The power management ECU 20 can receive the information about the feeding request from the matching ECU 24 to determine that the feeding request is issued.

At step S102, the power management ECU 20 determines whether or not the assembled battery 15 is in normal condition. The measures of the condition of the assembled battery 15 include the SOC, the voltage, and the temperature, for example. The determination of whether or not the assembled battery 15 is in normal condition can be made by using at least one of the determination parameters including the SOC, the voltage, and the temperature. When the assembled battery 15 is in normal condition, the power management ECU 20 proceeds to processing at step S103. When the assembled battery 15 is not in normal condition, the power management ECU 20 proceeds to the processing at step S109.

When the SOC of the assembled battery 15 is higher than the lower limit SOC and is lower than the upper limit SOC, the power management ECU 20 can determine that the assembled battery 15 is in normal condition. The lower limit SOC and the upper limit SOC can be preset in view of the input/output characteristics and the like of the assembled battery 15. The information about the set SOC can be stored in a memory.

When the SOC of the assembled battery 15 is lower than the lower limit SOC, the assembled battery 15 may be overdischarged and the power management ECU 20 determines that the assembled battery 15 is not in normal condition. When the SOC of the assembled battery 15 is higher than the upper limit SOC, the assembled battery 15 may be overcharged and the power management ECU 20 determines that the assembled battery 15 is not in normal condition.

The SOC of the assembled battery 15 can be obtained from the Open Circuit Voltage (OCV) of the assembled battery 15. Since the SOC and the OCV are associated with each other, the association between them can be previously found to obtain the SOC from the OCV. The OCV of the assembled battery 15 can be calculated from the voltage (CCV: Closed Circuit Voltage) of the assembled battery 15 detected by a voltage sensor. Alternatively, the SOC of the assembled battery 15 may be calculated by detecting the charge and discharge currents of the assembled battery 15 with a current sensor and summing the current values detected when the assembled battery 15 is charged and discharged.

Although the determination of whether or not the assembled battery 15 is in normal condition is made on the basis of the SOC of the assembled battery 15 in the present embodiment, the present invention is not limited thereto. The determination of whether or not the assembled battery 15 is in normal condition may be made on the basis of the SOC of the cell 15a forming the assembled battery 15. For example, when the SOC of the cell 15a is higher than the lower limit SOC and is lower than the upper limit SOC, the power management ECU 20 can determine that the assembled battery 15 is in normal condition. The lower limit SOC and the upper limit SOC of the cell 15a may be identical to or different from the lower limit SOC and the upper limit SOC of the assembled battery 15, respectively.

When the voltage of the assembled battery 15 is higher than the lower limit voltage and is lower than the upper limit voltage, the power management ECU 20 can determine that the assembled battery 15 is in normal condition. A voltage sensor can be used to detect the voltage of the assembled battery 15, and the information of the detection by the voltage sensor is input to the power management ECU 20. The lower limit voltage and the upper limit voltage can be preset in view of the input/output characteristics and the like of the assembled battery 15. The information about the set voltage can be stored in the memory.

When the voltage of the assembled battery 15 is lower than the lower limit voltage, the assembled battery 15 may be overdischarged and the power management ECU 20 determines that the assembled battery 15 is not in normal condition. When the voltage of the assembled battery 15 is higher than the upper limit voltage, the assembled battery 15 may be overcharged and the power management ECU 20 determines that the assembled battery 15 is not in normal condition.

Although the determination of whether or not the assembled battery 15 is in normal condition is made on the basis of the voltage of the assembled battery 15 in the present embodiment, the present invention is not limited thereto. The determination of whether or not the assembled battery 15 is in normal condition may be made on the basis of the voltage of the cell 15a forming the assembled battery 15. For example, when the voltage of each cell 15a is higher than the lower limit voltage and is lower than the upper limit voltage, the power management ECU 20 can determine that the assembled battery 15 is in normal condition. The lower limit voltage and the upper limit voltage of the cell 15a are different from the lower limit voltage and the upper limit voltage of the assembled battery 15, respectively.

When the temperature of the assembled battery 15 is higher than the lower limit temperature and is lower than the upper limit temperature, the power management ECU 20 can determine that the assembled battery 15 is in normal condition. A temperature sensor can be used to detect the temperature of the assembled battery 15, and the information of the detection by the temperature sensor is input to the power management ECU 20. The lower limit temperature and the upper limit temperature can be preset in view of the input/output characteristics and the like of the assembled battery 15. The information about the set temperature can be stored in the memory.

When the temperature of the assembled battery 15 is lower than the lower limit temperature or is higher than the upper limit temperature, the favorable output from the assembled battery 15 may not be ensured. In this case, the power management ECU 20 determines that the assembled battery 15 is not in normal condition.

At step S103, the power management ECU 20 determines whether or not the generator 18 is in normal condition. An exemplary measure of the condition of the generator 18 is the temperature of the generator 18. When the temperature of the generator 18 is higher than a predetermined threshold value, the power generation performance of the generator 18 is reduced. Thus, when the temperature of the generator 18 is higher than the threshold value, the power management ECU 20 determines that the generator 18 is not in normal condition.

The threshold value can be set as appropriate in view of the power generation performance and the like of the generator 18. The information about the threshold value can be stored in the memory. A temperature sensor can be used to detect the temperature of the generator 18, and the information of the detection by the temperature sensor is input to the power management ECU 20.

At step S104, the power management ECU 20 determines whether or not the vehicle is in normal condition. Specifically, the power management ECU 20 determines whether or not the system for supplying the electric power of the assembled battery 15 to the external device and the system for supplying the electric power generated by the generator 18 to the external device normally operate. For example, when the engine 17 or the generator 18 is out of order, the power management ECU 20 determines that the vehicle is not in normal condition.

At step S105, the power management ECU 20 determines whether or not the shift lever is unoperated. At the start of the processing shown in FIG. 2, the shift position is set at the P-range. The power management ECU 20 determines whether or not the shift position is changed from the P-range to another range based on the output from the shift sensor 33.

When the shift position is changed from the P-range to another range, the power management ECU 20 determines that the shift lever is operated. When the shift lever is unoperated, the power management ECU 20 proceeds to processing at step S106. When the shift lever is operated, the power management ECU 20 proceeds to the processing at step 109.

At step S106, the power management ECU 20 determines whether or not the accelerator pedal is unoperated on the basis of the output from the accelerator position sensor 32. It is assumed that the accelerator pedal is unoperated at the start of the processing shown in FIG. 2. When it is determined that the accelerator pedal is unoperated, the power management ECU 20 proceeds to processing at step S107. When it is determined that the accelerator pedal is operated, the power management ECU 20 proceeds to the processing at step S109.

At step S107, the power management ECU 20 determines whether or not the brake is unoperated on the basis of the output from the ECB-ECU 21. The operation of the brake includes the operation of the brake pedal and the operation of the parking brake. When the brake is unoperated, the power management ECU 20 proceeds to processing at step S108. When the brake is operated, the power management ECU 20 proceeds to the processing at step S109. Although the determination of whether or not both the brake pedal and the parking pedal are unoperated is made in the present embodiment, it may be determined whether or not one of the brake pedal and the parking pedal is unoperated.

At step S108, the power management ECU 20 can activate the feeding apparatus 16 to start feeding to the external device. Specifically, the power management ECU 20 switches the IG relays 11 and 12 from OFF to ON. Next, the power management ECU 20 operates the DC/DC converter 13 and switches the system main relay 14 from OFF to ON.

Once the system main relay 14 is switched from OFF to ON, the electric power of the assembled battery 15 can be supplied to the external device through the feeding apparatus 16. When the assembled battery 15 is discharged to reduce the voltage (or the SOC) of the assembled battery 15, the power management ECU 20 stops the discharge of the assembled battery 15. The power management ECU 20 can obtain the voltage or the SOC of the assembled battery 15 based on the output from the voltage sensor.

After the discharge of the assembled battery 15 is stopped, the engine ECU 22 receives control information from the power management ECU 20 to start the engine 17. With the start of the engine 17, the generator 18 receives the motive power from the engine 17 to generate the electric power which is then supplied to the external device through the feeding apparatus 16.

At step S108, the power management ECU 20 notifies a user of the start of the feeding through the use of a sound or display.

Specifically, the power management ECU 20 transmits information representing the start of the feeding to the meter ECU 23 or the matching ECU 24. In response to the information transmitted from the power management ECU 20, the meter ECU 23 can show feeding start information on the display mounted on the vehicle or output the feeding start information (sound) from the speaker mounted on the vehicle.

When the remote key 25 is provided with the display or the speaker, the matching ECU 24 transmits the feeding start information to the remote key 25. In response to the information from the matching ECU 24, the remote key 25 can show the feeding start information on the display or output the feeding start information (sound) from the speaker.

When the feeding start information is represented on the display, it is only required that the representation on the display should allow the user to recognize the start of the feeding. When the feeding start information is output as the sound from the speaker, it is only required that the sound information should allow the user to recognize the start of the feeding.

At step S109, the power management ECU 20 prohibits the operation of the feeding apparatus 16. When the supply of the electric power is in progress from the feeding apparatus 16 to the external device, that supply of the electric power to the external device is stopped.

At step S109, the power management ECU 20 notifies the user of a failure to perform the feeding with a sound or display. Specifically, the power management ECU 20 transmits information representing the failure to perform the feeding to the meter ECU 23 or the matching ECU 24. In response to the information transmitted from the power management ECU 20, the meter ECU 23 can show feeding prohibition information on the display mounted on the vehicle or output the feeding prohibition information (sound) from the speaker mounted on the vehicle.

When the remote key 25 is provided with the display or the speaker, the matching ECU 24 transmits the feeding prohibition information to the remote key 25. In response to the information from the matching ECU 24, the remote key 25 can show the feeding prohibition information on the display or output the feeding prohibition information (sound) from the speaker.

When the feeding prohibition information is shown on the display, it is only required that the representation on the display should allow the user to recognize the prohibition of the feeding. When the feeding prohibition information is output as the sound from the speaker, it is only required that the sound information should allow the user to recognize the prohibition of the feeding.

The power management ECU 20 can also notify the user of the prohibition of the feeding by driving a light mounted on the vehicle. For example, the light can be driven in a predetermined blinking pattern to notify the user of the prohibition of the feeding. Any light mounted on the vehicle can be used, and examples of the light include a headlight, a taillight, and a room light.

Information about the reason for the prohibition of the feeding can be shown on the display of the vehicle or the remote key 25. When the power management ECU 20 proceeds from the processing at steps S101 to S107 to the processing at step S109, the determination result in the processing at steps S101 to S107 can be regarded as the reason for the prohibition of the feeding. For example, when the shift lever is operated in the processing at step S105, the information representing the operation of the shift lever can be shown on the display as the reason for the prohibition of the feeding.

The information about the reason for the prohibition of the feeding can be output as the sound from the speaker. When the power management ECU 20 proceeds from the processing at steps S101 to S107 to the processing at step S109, the determination result in the processing at steps S101 to S107 can be regarded as the reason for the prohibition of the feeding. For example, when the shift lever is operated in the processing at step S105, the information representing the operation of the shift lever can be output as the sound to provide the reason for the prohibition of the feeding.

According to the present embodiment, the feeding from the feeding apparatus 16 to the external device is prohibited when the shift position is switched from the P-range to another range. In other words, the feeding to the external device can be performed only when the shift position is at the P-range. This can achieve the feeding to the external device while the vehicle is left stopped. When the external device is used remotely from the vehicle, the external device can be used continuously during the stop of the vehicle.

The transmission of the feeding start information or the feeding prohibition information to the remote key 25 allows the user to see the feeding information using the remote key 25 when the external device is used remotely from the vehicle. The user can check the state of the vehicle by recognizing the prohibition of the feeding to the external device using the remote key 25.

Since the engine 17 can be started while the shift position is at the P-range in the vehicle of the present embodiment, the reliable start of the engine 17 can be ensured while the feeding to the external device is performed.

Although the processing from step S105 to step S107 is performed in the present embodiment, the present invention is not limited thereto. It is only required that at least the processing at step S105 out of the processing from step S105 to step S107 should be performed.

Although the feeding from the feeding apparatus 16 to the external device is prohibited in the present embodiment, the present invention is not limited thereto. For example, the operation of the system shown in FIG. 1 may be prohibited in the processing at step S109. The prohibition of the operation of the system switches the system main relay 14 from ON to OFF.

Although the vehicle (so-called hybrid vehicle) including the assembled battery 15 and the engine 17 as the motive power sources for running the vehicle is described in the present embodiment, the present invention is not limited thereto.

For example, the present invention is applicable to a vehicle (so-called electric vehicle) including only the assembled battery 15 as the motive power source for the vehicle. In the electric vehicle, the engine 17 and the generator 18 shown in FIG. 1 are omitted, and the electric power of the assembled battery 15 is supplied to the external device through the feeding apparatus 16. Alternatively, the present invention is applicable to a vehicle including only the engine 17 as the motive power source for the vehicle. In this case, the assembled battery 15 shown in FIG. 1 is omitted, and the electric power of the generator 18 is supplied to the external device through the feeding apparatus 16.

A charge system for supplying the electric power of an external power source to the assembled battery 15 can be mounted on the vehicle. The external power source is a power source provided outside the vehicle and independently of the vehicle, and an example of the external power source is a commercial power source. When the external power source supplies an AC power, a charger mounted on the vehicle can convert the AC power into a DC power. Then, the charger can supply the DC power to the assembled battery 15. When the external power source supplies a DC power, the DC power can be supplied to the assembled battery 15.

1. A vehicle comprising:
a feeding system supplying an electric power to an external device disposed outside the vehicle;
a controller controlling operation of the feeding system; and
a shift sensor detecting a position of a shift lever and outputting the detection result to the controller,
wherein the controller prohibits feeding from the feeding system to the external device when the position of the shift lever is changed.

2. The vehicle according to claim 1, wherein the feeding system includes an electric storage apparatus outputting an electric power used in running of the vehicle and an electric power to be supplied to the external device.

3. The vehicle according to claim 1, wherein the feeding system includes an engine producing a motive power through combustion of a fuel and a generator receiving the motive power from the engine to generate an electric power.

4. The vehicle according to claim 1, wherein the controller prohibits the feeding to the external device when the position of the shift lever is changed from a parking range to another range.

5. The vehicle according to claim 1, further comprising an accelerator position sensor detecting operation of an accelerator pedal and outputting the detection result to the controller,
wherein the controller prohibits the feeding from the feeding system to the external device when the position of the shift lever is unchanged and the accelerator pedal is operated.

6. The vehicle according to claim 1, further comprising a brake sensor detecting operation of a brake and outputting the detection result to the controller,
wherein the controller prohibits the feeding from the feeding system to the external device when the position of the shift lever is unchanged and the brake is operated.

7. The vehicle according to claim 1, further comprising an information output unit outputting predetermined information,
wherein the controller causes the information output unit to output feeding prohibition information when the feeding to the external device is prohibited.

8. The vehicle according to claim 7, wherein the information output unit is a display or a speaker.

9. The vehicle according to claim 7, wherein the information output unit transmits the feeding prohibition information to a portable device.

10. The vehicle according to claim 9, wherein the portable device includes a display, and
the information output unit transmits information to be shown on the display as the feeding prohibition information.

11. The vehicle according to claim 9, wherein the portable device includes a speaker, and
the information output unit transmits sound information to be output from the speaker as the feeding prohibition information.

12. The vehicle according to claim 7, wherein the feeding prohibition information includes information representing the prohibition of the feeding and information representing a reason for the prohibition of the feeding.

13. A control method of controlling operation of a feeding system mounted on a vehicle and supplying an electric power to an external device disposed outside the vehicle, comprising:
detecting a position of a shift lever using a shift sensor; and
prohibiting feeding from the feeding system to the external device when the position of the shift lever is changed.

14. The control method according to claim 13, wherein the feeding to the external device is prohibited when the position of the shift lever is changed from a parking range to another range.

15. The control method according to claim 13, wherein an accelerator position sensor is used to detect operation of an accelerator pedal, and the feeding from the feeding system to the external device is prohibited when the position of the shift lever is unchanged and the accelerator pedal is operated.

16. The control method according to claim 13, wherein a brake sensor is used to detect operation of a brake, and the feeding from the feeding system to the external device is prohibited when the position of the shift lever is unchanged and the brake is operated.

17. The control method according to claim 13, wherein feeding prohibition information is outputted by an information output unit when the feeding to the external device is prohibited.

18. The control method according to claim 17, wherein the information output unit is used to transmit the feeding prohibition information to a portable device.

19. The control method according to claim 17, wherein the feeding prohibition information includes information representing the prohibition of the feeding and information representing a reason for the prohibition of the feeding.

20. The vehicle according to claim 2, wherein the feeding system includes an engine producing a motive power through combustion of a fuel and a generator receiving the motive power from the engine to generate an electric power.
